(19) United States
(12) Patent Application Publication
(10) Pub. No.: US 2014/0131905 A1
(43) Pub. Date: May 15, 2014

(54) PROCESS FOR MANUFACTURING AN INTRAOCULAR LENS

(71) Applicant: AcuFocus, Inc., Irvine, CA (US)

(72) Inventor: Kyle Webb, Carlsbad, CA (US)

(21) Appl. No.: 13/829,822

(22) Filed: Mar. 14, 2013

Related U.S. Application Data
(60) Provisional application No. 61/724,718, filed on Nov. 9, 2012.

(51) Int. Cl. B29D 11/00

(52) U.S. Cl. CPC B29D 11/0073; B29D 11/0048
USPC 264/1.7; 425/500

(57) ABSTRACT

Intraocular implants and methods of making intraocular implants are provided. The intraocular implant can include a mask adapted to increase depth of focus. The method of making the intraocular implant can include suspending the mask along an optical axis of the intraocular implant using a centration tool.

### CROSS-REFERENCE TO RELATED APPLICATIONS

This application claims a priority benefit under 35 U.S.C. §119(e) to U.S. Provisional Application No. 61/724,718, filed Nov. 9, 2012, entitled “PROCESS FOR MANUFACTURING AN INTRAOCULAR LENS,” which is hereby incorporated by reference in its entirety.

### BACKGROUND

1. Field

This application relates generally to the field of intraocular devices. More particularly, this application is directed to intraocular implants and lenses (IDLs) with an aperture to increase depth of focus (e.g. “masked” intraocular lenses), and methods of making the same.

2. Description of the Related Art

The human eye functions to provide vision by transmitting and focusing light through a clear outer portion called the cornea, and further refining the focus of the image onto a retina by way of a crystalline lens. The quality of the focused image depends on many factors including the size and shape of the eye, and the transparency of the cornea and the lens.

The optical power of the eye is determined by the optical power of the cornea and the crystalline lens. In a normal, healthy eye, sharp images of distant objects are formed on the retina (emmetropia). In many eyes, images of distant objects are either formed in front of the retina because the eye is abnormally long or the cornea is abnormally steep (myopia), or formed in back of the retina because the eye is abnormally short or the cornea is abnormally flat (hyperopia). The cornea also may be asymmetric or toric, resulting in an uncompensated cylindrical refractive error referred to as corneal astigmatism.

Some people suffer from cataracts in which the crystalline lens undergoes a loss of transparency. In such cases, the crystalline lens can be removed and replaced with an intraocular lens (IOL). However, some intraocular lenses may still leave defects in a patient's non-distance eyesight.

### SUMMARY

This application is directed to intraocular implants for improving the vision of a patient, such as by increasing the depth of focus of an eye of a patient. The intraocular implants can include a mask having an annular portion with a relatively low visible light transmission surrounding a relatively high transmission central portion such as a clear lens or aperture. This construct is adapted to provide an annular mask with a small aperture for light to pass through to the retina to increase depth of focus. The intraocular implant may have an optical power for refractive correction. For example, the mask can be embodied in or combined with intraocular lenses (IDLs). The intraocular implant may be implanted in any location along the optical pathway in the eye, e.g., as an implant in the anterior or posterior chamber. A first aspect of manufacturing an intraocular lens can include partially curing a first amount of uncured lens material to form at least part of a lens body, suspending a mask on the partially cured lens material, adding a second amount of uncured lens material to the partially cured lens material, and curing the second amount of uncured lens material and the partially cured lens material to form the lens body, the lens body comprising the mask therein.

The first aspect of manufacturing the IOL can include curing the first amount of uncured lens material between about 20 percent and about 40 percent of a full cure. In some embodiments, the first amount of uncured lens material is cured to about 30 percent of a full cure.

In any of the above mentioned aspects of manufacturing the IOL, the first amount of uncured lens material can include about 50 percent of a total amount of uncured lens material used to form the lens body.

In any of the above mentioned aspects of manufacturing the IOL, suspending the mask can include centering the mask along an optical axis of the intraocular lens. Centering the mask can include using a centration tool. Before curing the uncured lens material and the partially cured lens material, the centration tool can be removed. The centration tool can include a tine plate.

In any of the above mentioned aspects of manufacturing the IOL, the mask can include a plurality of holes characterized in that at least one of a hole size, shape, orientation, and spacing of the plurality of holes is varied to reduce the tendency of the holes to produce visible diffraction patterns. The plurality of holes can be positioned at irregular locations. The lens body can extend through the plurality of holes of the mask. For example, the uncured lens material can be made to flow through the plurality of holes. The plurality of holes are described in U.S. Pub. No. 2011/0040376, filed Aug. 13, 2010, which is hereby incorporated by reference in its entirety.

Another aspect of manufacturing an intraocular lens can include forming a thin film from a thin film material, positioning a mask on the thin film, filling at least a part of a mold with a lens material, suspending the thin film in the mold, and curing the lens material.

In this aspect of manufacturing the IOL, suspending the thin film in the mold can include centering the mask along an optical axis of the intraocular lens. Centering the mask can include using one or more pins of the mold to center the mask. Suspending the thin film in the mold can include centering an insert along an optical axis of the intraocular lens.

In any of the above mentioned aspects of manufacturing the IOL, the remainder of the mold can be filled with the lens material after suspending the thin film in the mold.

In any of the above mentioned aspects of manufacturing the IOL, forming a thin film can include partially curing the thin film material. Partially curing the thin film material can include curing the thin film material between about 20 percent and 40 percent of a full cure.

In any of the above mentioned aspects of manufacturing the IOL, the mask can include a mask material, and the thin film material can be the same as the mask material. In any of the above mentioned aspects of manufacturing the IOL, the thin film material can be different from the mask material.

In any of the above mentioned aspects of manufacturing the IOL, the thin film material can be silicone or acrylic.

In any of the above mentioned aspects of manufacturing the IOL, the mask can include a mask material, the mask material can be the same as the lens material.

In any of the above mentioned aspects of manufacturing the IOL, the mask can include polymers (e.g. PMMA, PVDF, polypropylene, polycarbonate, PEEK, polyethylene, acrylic copolymers (e.g., hydrophobic or hydrophilic), polystyrene, PVC, polysulfone), hydrogels, silicone, metals, metal alloys, carbon (e.g., graphene, pure carbon), or Dacron mesh.

In any of the above mentioned aspects of manufacturing the IOL, the mask can include a highly fluorinated polymer.

In any of the above mentioned aspects of manufacturing the IOL, a diameter of the thin film can be greater than a diameter of the intraocular lens. Joining a first mold section and a second mold section can remove an excess diameter of the thin film.

Yet another aspect of manufacturing the intraocular lens tool can include a centration tool for suspending a mask in an intraocular lens. The centration tool can include a first section having a diameter at least as large as a diameter of the intraocular lens, and a second section having a raised element centered along an optical axis of the intraocular lens, the raised element being configured to support and position the mask such that the mask can be formed in the intraocular lens.

In this aspect of the centration tool, the first section can include at least one aperture through which a corresponding pin of a mold extends when the intraocular lens is being formed.

In any of the above mentioned aspects of the centration tool, the first section can be a tine plate.

In any of the above mentioned aspects of the centration tool, the second section can include an aperture.

In any of the above mentioned aspects of the centration tool, the second section can include at least one elongated member to support the second section with respect to the first section.

In any of the above mentioned aspects of the centration tool, the second section and the first section can be separable.

For purposes of summarizing the disclosure, certain aspects, advantages and features of the inventions have been described herein. It is to be understood that not necessarily any or all such advantages are achieved in accordance with any particular embodiment of the inventions disclosed herein. No aspects of this disclosure are essential or indispensable.

### BRIEF DESCRIPTION OF THE DRAWINGS

FIG. 1A illustrates a top view of an example intraocular lens having an embedded mask.

FIG. 1B illustrates a cross-sectional view of the intraocular lens of FIG. 1A.

FIG. 2A is a perspective view of one embodiment of a mask configured to increase depth of focus.

FIG. 2B is a perspective view of an embodiment of a substantially flat mask configured to increase depth of focus.

FIG. 3A is a top view of another embodiment of a mask configured to increase depth of focus.

FIG. 3B is an enlarged view of a portion of the view of FIG. 3A.

FIG. 4 is a cross-sectional view of the mask of FIG. 3B taken along the section plane 4-4.

FIG. 5 is a graphical representation of one arrangement of holes of a plurality of holes that may be formed in the mask.

FIG. 6 is a flow chart illustrating one method for making an intraocular lens comprising a mask configured to increase depth of focus.

FIG. 7 is a flow chart illustrating another method for making an intraocular lens comprising a mask configured to increase depth of focus.

FIG. 8 illustrates a centration tool for centering a mask in an intraocular lens.

FIGS. 9A-C illustrate a section of the centration tool of FIG. 8.

FIGS. 10A-C illustrate another centration tool for centering a mask in an intraocular lens.

FIG. 11 is a flow chart illustrating one method for making an intraocular lens using a thin film.

FIG. 12 is a flow chart illustrating another method for making an intraocular lens using a thin film.

FIGS. 13 illustrate a thin film for use with the methods illustrated in FIGS. 11 and 12.

### DETAILED DESCRIPTION

As discussed herein, people who undergo intraocular lens (IOL) implantation surgery may still suffer from defects in their non-distance eyesight. One technique for treating such defects is by including a mask within the IOL that increases the patient's depth of focus. The intraocular implants of the preferred embodiments include a mask adapted to provide a small aperture for light to pass through to the retina to increase depth of focus. The light rays that pass through the mask within the IOL converge at a single focal point on the retina, while the light rays that would not converge at the single point on retina are blocked by the mask. This disclosure describes methods for manufacturing a lens, such as an IOL, having an embedded mask.

Several alternatives to fixed-focus IDLs have been developed, including multifocal IDLs and accommodating IDLs, that attempt to provide the ability to see clearly at both near and far distances. However, accommodating IDLs can be complex and some multifocal IDLs do not perform well at intermediate distances and cause glare, halos, and night vision difficulties associated with the presence of unfocused light. This limitation can force designers of multifocal optics to choose how much of the light is directed to each focal point, and to deal with the effects of the unfocused light that is always present in any image. In order to maximize acuity at the important distances of infinity (>6M) and 40 cm (normal reading distance), it is typical to provide little or no light focused at an intermediate distance, and as a result, visual acuity at these distances is poor. With a mask that includes an aperture to increase depth-of-focus, however, the intermediate and near vision of a patient can be improved significantly.

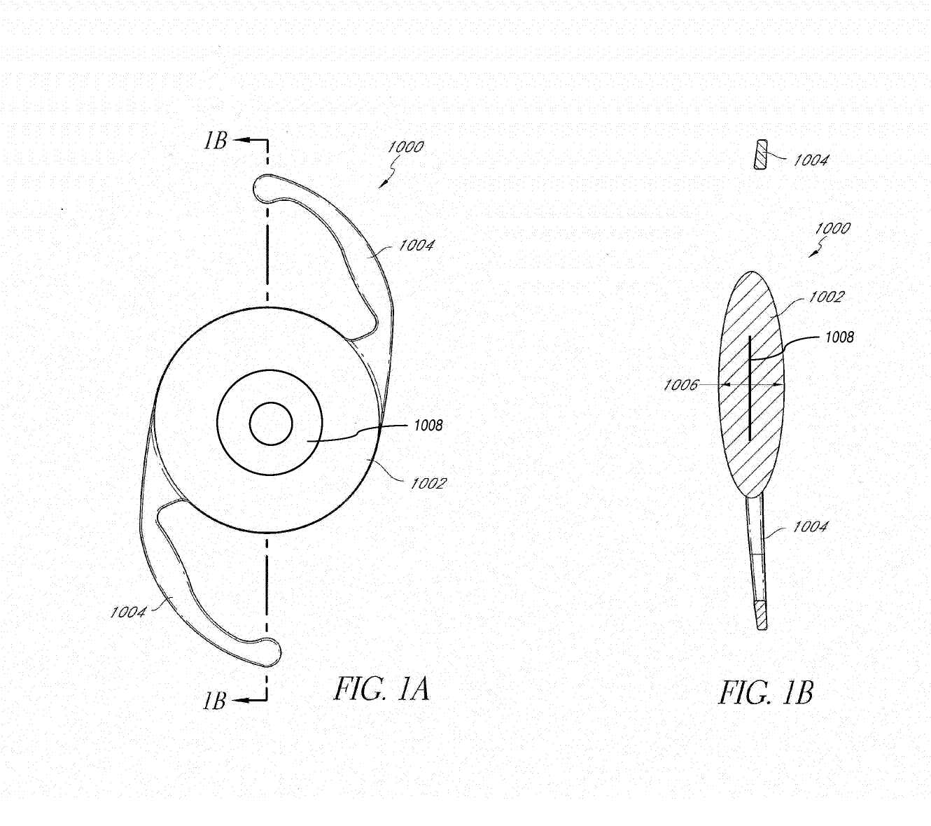

FIGS. 1A-B illustrate an example embodiment of an intraocular lens having an embedded mask 1008 for increasing depth of focus. The intraocular lens 1000 includes haptics 1004 for positioning the lens within the eye. The cross-sectional thickness of the lens body 1002 is generally dependent on the optical power of the intraocular lens 1000 and the material of the lens body 1002. In particular, the central region of the lens body 1002 is generally the thickest section of the intraocular lens 1000 with a central region cross-sectional thickness 1006. Methods for reducing the thickness of the intraocular lens are described in U.S. Pub. No. 2011/0040376, filed Aug. 13, 2010, which is hereby incorporated by reference in its entirety.

The intraocular lens and/or the lens body can be made from one or more materials. In certain embodiments, the intraocular lens material can include, for example, a high-viscosity material, though this is not required. In certain embodiments, the intraocular lens and/or the lens body can comprise polymers (e.g. PMMA, PVDF, polypropylene, polycarbonate, PEEK, polyethylene, acrylic copolymers, polystyrene, PVC, polysulfone), hydrogels, and silicone.

### Masks

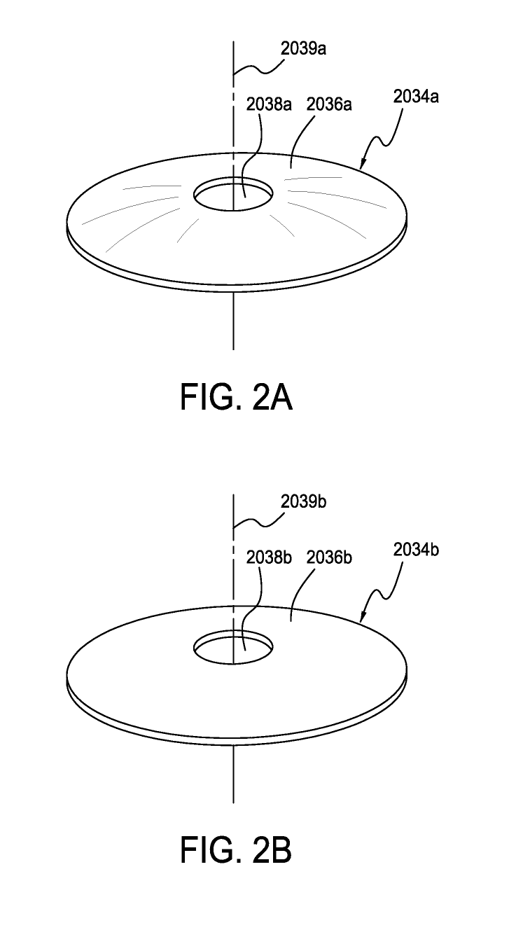

A variety of variations of masks that can be positioned on or within the implant body are discussed herein, and also described in U.S. Pat. No. 7,628,810, U.S. Patent Publication No. 2006/0113054, and U.S. Patent Publication No. 2006/0265058, all of which are hereby incorporated by reference in their entirety. FIG. 2A illustrates one embodiment of a mask 2034a. The mask 2034a can include an annular region 2036a surrounding an aperture 2038a substantially centrally located on the mask 2034a. The aperture 2038a can be generally located around a central axis 2039a, referred to herein as the optical axis of the mask 2034a. The aperture 2038a can be in the shape of a circle. FIG. 2B illustrates another embodiment of a mask 2034b similar to the mask 2034a illustrated in FIG. 2A. The annular region 2036a of the mask 2034a of FIG. 2A has a curvature from the outer periphery to the inner periphery of the annular region 2036a, while the annular region 2036b of the mask 2034b of FIG. 2B can be substantially flat.

The mask can have dimensions configured to function with the implant body to improve a patient's vision. For example, the thickness of the mask can vary depending on the location of the mask relative to the implant body. For example, if the mask is embedded within the implant body, the mask can have a thickness greater than zero and less than the thickness of the implant body. Alternatively, if the mask is coupled to a surface of the implant body, the mask may preferably have a thickness no greater than necessary to have desired opacity so that the mask does not add additional thickness to the intraocular lens.

The mask may have a constant thickness, as discussed below. However, in some embodiments, the thickness of the mask may vary between the inner periphery (near the aperture 2038a,b) and the outer periphery.

The annular region 2036a,b can be at least partially opaque or can be completely opaque. The degree of opacity of the annular region 2036a,b can prevent at least some or substantially all light from being transmitted through the mask 2034a,b. Opacity of the annular region 2036a,b can be achieved in any of several different ways.

For example, in some embodiments, the material used to make mask 2034a,b can be naturally opaque. In some embodiments, the material used to make the mask 2034a,b can be substantially clear, but treated with a dye or other pigmentation agent to render region 2036a,b substantially or completely opaque. In some embodiments, the surface of the mask 2034a,b can be treated physically or chemically (such as by etching) to alter the refractive and transmissive properties of the mask 2034a,b and make it less transmissive to light.

The material of the mask 2034a,b can be, for example, any polymeric material. Where the mask 2034a,b is applied to the intraocular implant, the material of the mask 2034a,b should be biocompatible. Examples of suitable materials for the mask 2034a,b can include, but are not limited to, highly fluorinated polymers, such as PVDF, hydrogels, or fibrous materials, such as a Dacron mesh.

In some embodiments, a photochromic material can be used as the mask or in addition to mask. Under bright light conditions, the photochromic material can darken thereby creating a mask and enhancing near vision. Under dim light conditions, the photochromic material can lighten, which allows more light to pass through to the retina. In certain embodiments, under dim light conditions, the photochromic material lightens to expose an optic of the intraocular implant. Further photochromic material details are disclosed in U.S. patent application Ser. No. 13/691,625, filed Nov. 30, 2012, which is hereby incorporated by reference in its entirety.

The mask can have different degrees of opacity. For example, the mask can block substantially all of visible light or a portion of visible light. The opacity of the mask can also vary in different regions of the mask. In certain embodiments, the opacity of the outer edge and/or the inner edge of the mask can be less than the central region of the mask. The opacity in different regions can transition abruptly or have a gradient transition. Additional examples of opacity transitions can be found in U.S. Pat. Nos. 5,662,706, 5,905,561 and 5,965,330, all of which are hereby incorporated by reference in their entirety.

Further mask details are disclosed in U.S. Pat. No. 4,976,732, issued Dec. 11, 1990, U.S. Pat. No. 7,628,810, issued Dec. 8, 2009, and in U.S. patent application Ser. No. 10/854,032, filed May 26, 2004, all of which are hereby incorporated by reference in their entirety.

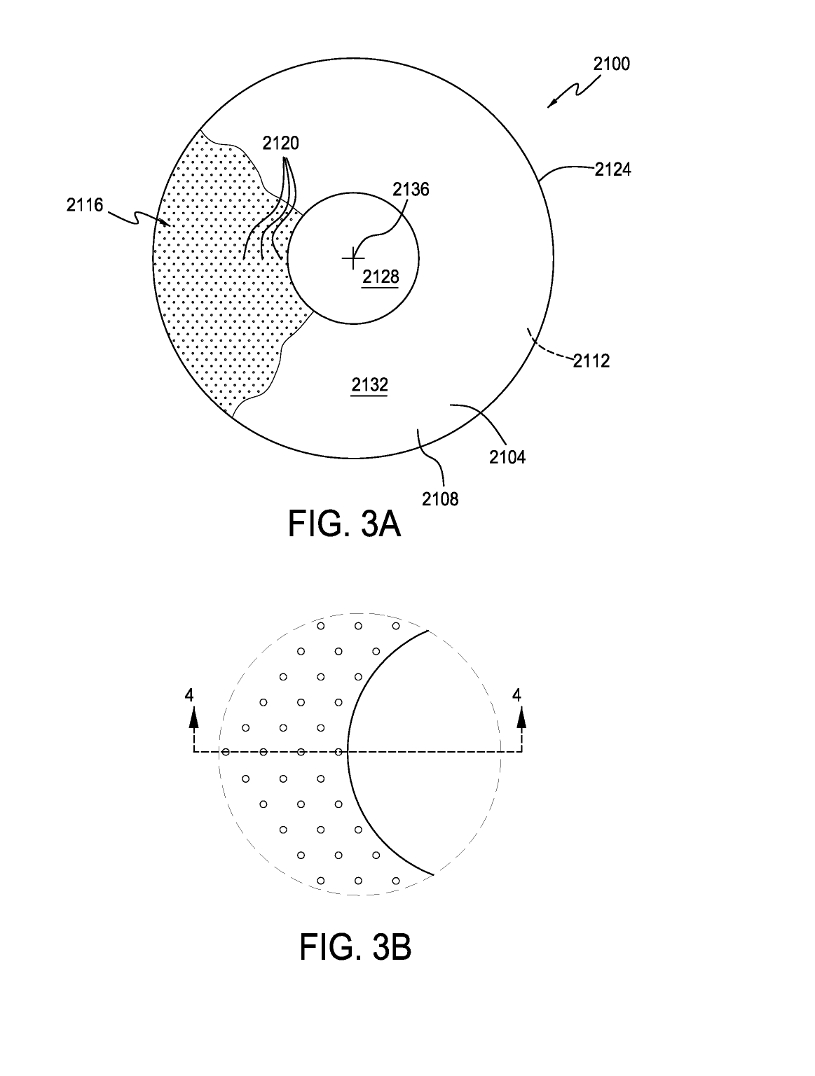

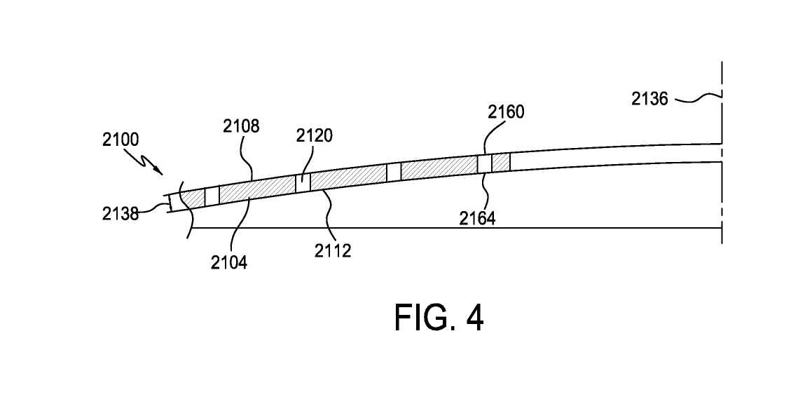

FIGS. 3-4 show another embodiment of a mask 2100 configured to increase depth of focus of an eye of a patient with presbyopia. The mask 2100 can be similar to the masks hereinbefore described, except as described differently below. The mask 2100 can be made of the materials discussed herein, including those discussed above. In addition, the mask 2100 can be formed by any suitable process. The mask 2100 can be configured to be applied to and/or embedded in an IOL.

In some embodiments, the mask 2100 can include a body 2104 that has an anterior surface 2108 and a posterior surface 2112. The body 2104 can be formed of any suitable material, including, but not limited to, at least one of an open cell foam material, an expanded solid material, and/or a substantially opaque material. In some embodiments, the material used to form the body 2104 can have relatively high water content. In some embodiments, the materials that can be used to form the body 2104 include polymers (e.g. PMMA, PVDF, polypropylene, polycarbonate, PEEK, polyethylene, acrylic copolymers (e.g., hydrophobic or hydrophilic), polystyrene, PVC, polysulfone), hydrogels, silicone, metals, metal alloys, or carbon (e.g., graphene, pure carbon).

In some embodiments, the mask 2100 can include a hole arrangement 2116. The hole arrangement 2116 can include a plurality of holes 2120. The holes 2120 are shown on only a portion of the mask 2100, but the holes 2120 can be located throughout the body 2104 in some embodiments. The mask 2100 can include an outer periphery 2124 that defines an outer edge of the body 2104. In some embodiments, the mask 2100 can include an aperture 2128 at least partially surrounded by the outer periphery 2124 and a non-transmissive portion 2132 located between the outer periphery 2124 and the aperture 2128.

The mask 2100 can be symmetrical, e.g., symmetrical about a mask axis 2136. In some embodiments, the outer periphery 2124 of the mask 2100 can be circular. The mask in general can have an outer diameter of at least about 3 mm and/or less than about 6 mm. In some embodiments, the mask is circular and can include a diameter of at least about 3 mm and/or less than or equal to about 4 mm. In some embodiments, the mask 2100 is circular and can include a diameter of about 3.2 mm.

In some embodiments, one of the anterior surface 2108 and the posterior surface 2112 of the body 2104 can be substantially planar. In some embodiments, very little or no uniform curvature can be measured across the planar surface. In some embodiments, both of the anterior and posterior surfaces 2108, 2112 can be substantially planar. In general, the thickness of the body 2104 of the mask 2100 can be within the range of from greater than zero to about 0.5 mm, about 1 micron to about 40 microns, in the range from about 5 microns to about 20 microns, or otherwise. In some embodiments, the body 2104 of the mask 2100 can include a thickness 2138 of at least about 5 microns and/or less than or equal to about 20 microns. In some embodiments, the body 2104 of the mask can include a thickness 2138 of at least about 5 microns and/or less than or equal to about 15 microns. In certain embodiments, the thickness 2138 can be about 15 microns, about 10 microns, about 8 microns, about 5 microns, or otherwise.

A substantially planar mask can have several advantages over a non-planar mask. For example, a substantially planar mask can be fabricated more easily than one that has to be formed to a particular curvature. In particular, the process steps involved in inducing curvature in the mask 2100 can be eliminated.

The aperture 2128 can be configured to transmit substantially all incident light along the mask axis 2136. The non-transmissive portion 2132 can surround at least a portion of the aperture 2128 and substantially prevent transmission of incident light thereon. As discussed in connection with the above masks, the aperture 2128 can be a through-hole in the body 2104 or a substantially light transmissive (e.g., transparent) portion thereof. The aperture 2128 of the mask 2100 can generally be defined within the outer periphery 2124 of the mask 2100. The aperture 2128 can take any of suitable configuration, such as those described above.

In some embodiments, the aperture 2128 can be substantially circular and can be substantially centered in the mask 2100. The size of the aperture 2128 can be any size that is effective to increase the depth of focus of an eye of a patient with presbyopia. In particular, the size of the aperture 2128 can be dependent on the location of the mask within the eye (e.g., distance from the retina). In some embodiments, the aperture 2128 can have a diameter of at least about 0.85 mm and/or less than or equal to about 2.2 mm. In certain embodiments, the diameter of the aperture 2128 is less than about 2 mm. In some embodiments, the diameter of the aperture is at least about 1.1 mm and/or less than or equal to about 1.6 mm. In some embodiments, the diameter of the aperture is at least about 1.3 mm and/or less than or equal to about 1.4 mm.

The non-transmissive portion 2132 can be configured to prevent transmission of visible light through the mask 2100. For example, in some embodiments, the non-transmissive portion 2132 can prevent transmission of substantially all or at least a portion of the spectrum of the incident visible light. In some embodiments, the non-transmissive portion 2132 can be configured to prevent transmission of substantially all visible light, e.g., radiant energy in the electromagnetic spectrum that is visible to the human eye. The non-transmissive portion 2132 can substantially prevent transmission of radiant energy outside the range visible to humans in some embodiments.

As discussed above, preventing transmission of light through the non-transmissive portion 2132 can decrease the amount of light that reaches the retina and the fovea that would not converge at the retina and fovea to form a sharp image. As discussed above, the size of the aperture 2128 is such that the light transmitted therethrough generally converges at the retina or fovea. Accordingly, a much sharper image can be presented to the retina than would otherwise be the case without the mask 2100.

In some embodiments, the non-transmissive portion 2132 can prevent transmission of at least about 90 percent of incident light. In some embodiments, the non-transmissive portion 2132 can prevent transmission of at least about 95 percent of all incident light. The non-transmissive portion 2132 of the mask 2100 can be configured to be substantially opaque to prevent the transmission of light.

In some embodiments, the non-transmissive portion 2132 can transmit no more than about 5% of incident visible light. In some embodiments, the non-transmissive portion 2132 can transmit no more than about 3% of incident visible light. In some embodiments, the non-transmissive portion 2132 can transmit no more than about 2% of incident visible light. In some embodiments, at least a portion of the body 2104 is configured to be opaque to more than 99 percent of the light incident thereon.

As discussed above, the non-transmissive portion 2132 may be configured to prevent transmission of light without absorbing the incident light. For example, the mask 2100 could be made reflective or could be made to interact with the light in a more complex manner, as discussed in U.S. Pat. No. 6,554,424, issued Apr. 29, 2003, which is hereby incorporated by reference in its entirety.

As discussed above, the mask 2100 can include a plurality of holes 2120. When the mask is formed embedded in the lens body, the lens body can extend at least partially through the holes, thereby creating a bond (e.g. material “bridge”) between the lens body on either side of the mask. Further disclosure regarding the material “bridge” can be found in U.S. Publication No. 2011/0040376, filed Aug. 13, 2010, which is hereby incorporated by reference in its entirety.

The holes 2120 of the mask 2100 shown in FIG. 3A can be located anywhere on the mask 2100. In some embodiments, substantially all of the holes are in one or more regions of a mask. The holes 2120 of FIG. 3A extend at least partially between the anterior surface 2108 and the posterior surface 2112 of the mask 2100. In some embodiments, each of the holes 2120 includes a hole entrance 2160 and a hole exit 2164. The hole entrance 2160 is located adjacent to the anterior surface 2108 of the mask 2100. The hole exit 2164 is located adjacent to the posterior surface 2112 of the mask 2100. In some embodiments, each of the holes 2120 extends the entire distance between the anterior surface 2108 and the posterior surface 2112 of the mask 2100. Further details about possible hole patterns are described in WO 2011/020074, filed Aug. 13, 2010, which is hereby incorporated by reference in its entirety.

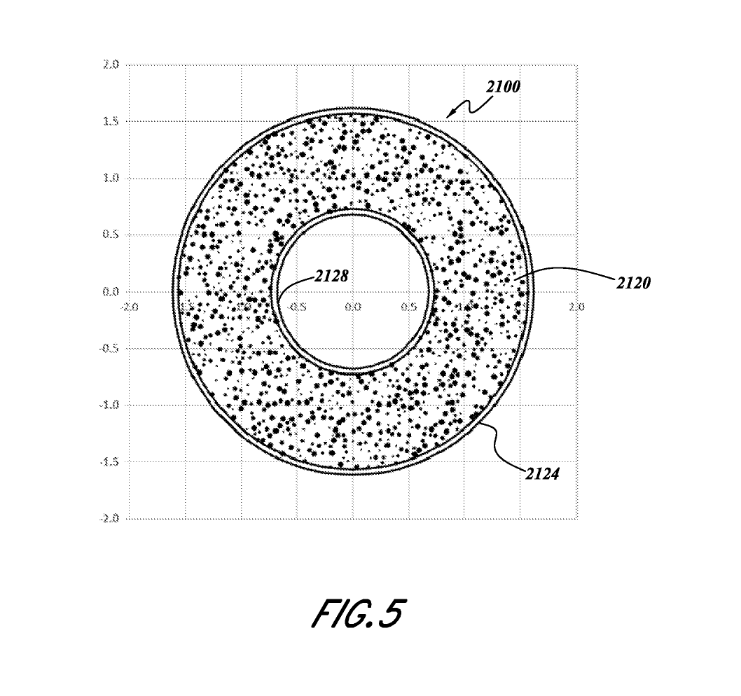

FIG. 5 illustrates an example embodiment of a mask 2100. For example, the mask 2100 can include an annular region near the outer periphery 2124 of the mask having no holes. In certain embodiments, there are no holes within 0.1 mm of the outer periphery 2124 of the mask 2100.

In some embodiments, the mask can include an annular region around the inner periphery of the mask having no holes. In certain embodiments, there are no holes within 0.1 mm of the aperture 2128.

In some embodiments, the holes 2120 each have a same diameter. In certain embodiments, the holes 2120 can include one or more different diameters. In some embodiments, the diameter of any single hole 2120 is at least about 0.01 mm and/or less than or equal to about 0.02 mm. In some embodiments, the diameter of the holes 2120 can include one or more of the following hole diameters: 0.010 mm, 0.013 mm, 0.016 mm, and/or 0.019 mm. In some embodiments, holes of different diameters are interspersed throughout at least a portion of the mask 2100. In some embodiments, the holes are interspersed at irregular locations throughout at least a portion of the mask 2100.

In some embodiments there are at least about 1000 holes and/or less than or equal to about 2000 holes. In some embodiments, there are at least about 1000 holes and/or less than or equal to about 1100 holes. In some embodiments, there are about 1040 holes. In some embodiments, there are an equal number of holes of each diameter. In some embodiments, the number of holes having each diameter is different.

In some embodiments, the holes are interspersed at irregular locations throughout at least a portion of the mask 2100. In some embodiments, holes of different diameters are evenly interspersed throughout at least a portion of the mask 2100. For example, the mask 2100 can include a plurality of non-overlapping hole regions. The sum of the surface area of the plurality of non-overlapping hole regions can equal to total surface area of the entire hole region of the mask. Each region of the plurality of regions can include a number of holes, each of the holes having a different diameter. The number of holes in each region can equal the number of different hole sizes in the entire hole region.

### Methods of Making an Intraocular Lens

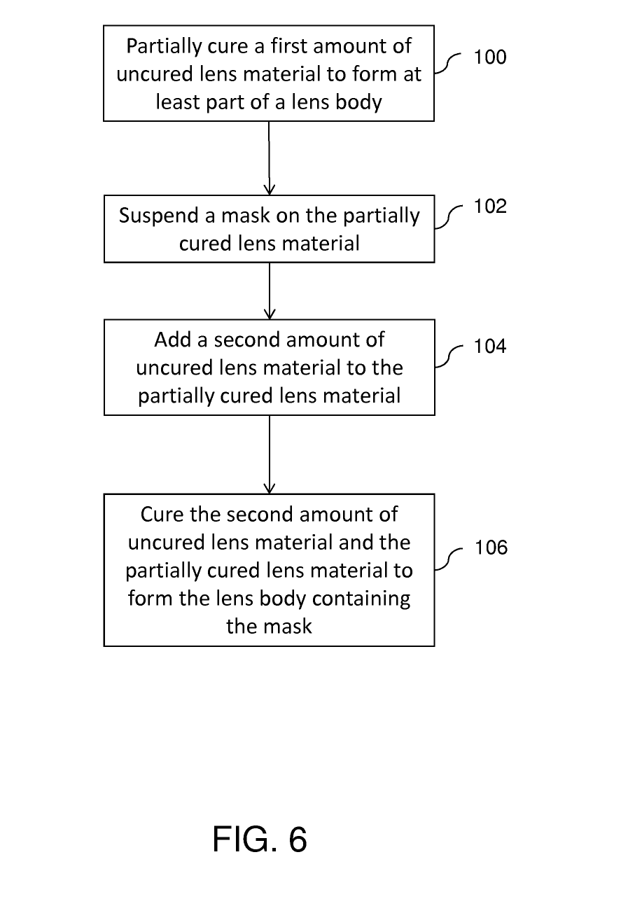

FIG. 6 illustrates a method of making the intraocular lens containing the mask. The method can include partially curing a first amount of uncured lens material to form at least part of a lens body (block 100). A mask can be suspended on the partially cured lens material (block 102). A second amount of uncured lens material can be added to the partially cured lens material (block 104). The partially cured lens material and the second amount of uncured lens material can be cured to form the lens body (block 106).

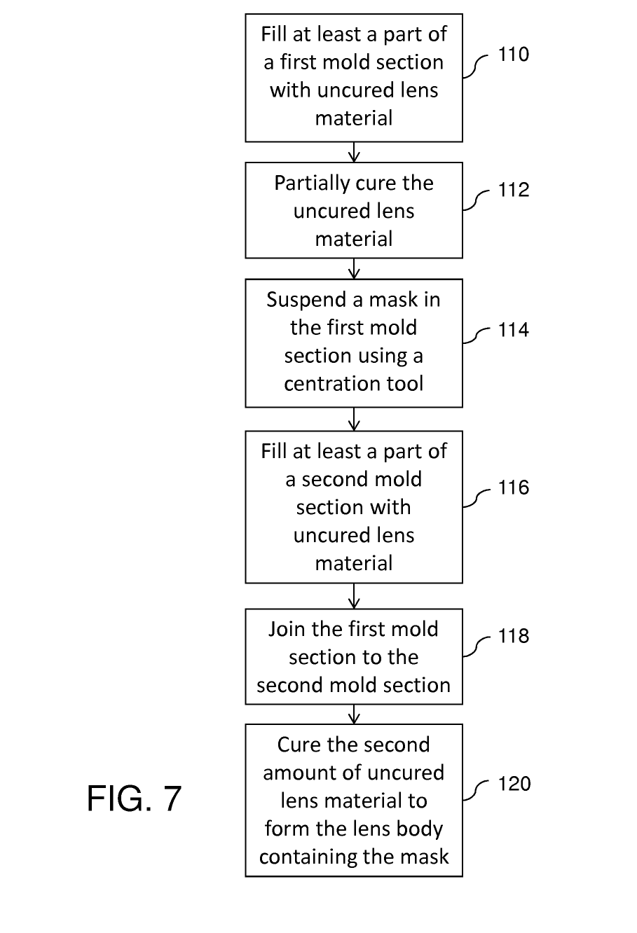

As shown in FIG. 7, a method of making the intraocular lens can include filling at least a part of a first mold section (e.g., a half of a clamshell mold) with a first amount of uncured lens material (block 110). The uncured lens material can be, for example, in a liquid or other physical state such that it can flow into the first mold section. The first amount of uncured lens material can be partially cured to form at least part of a lens body (block 112). In the partially cured state, the lens material can be at least somewhat hardened or solidified, as compared to the uncured lens material. The mask can be suspended on the now partially cured lens material, which may be cured at least enough to support the weight of the mask at a desired location within the lens while the lens is formed. The mask can be positioned in the first mold section using a centration tool (block 114). A second mold section (e.g., another half of a clamshell mold) can be filled with a second amount of uncured lens material (block 116). The first mold section and the second mold section can be joined together (block 118), and the partially cured lens material and the second amount of uncured lens material can be cured to form the lens body (block 120).

The first amount of material can vary depending on the desired location of the mask within the completed intraocular lens. For example, if the mask is to be positioned near the centroid of the lens body, then the first amount of material can be about 50 percent of the total amount of lens material. If the mask is to be positioned between the center of the lens body thickness and a surface of the lens body, then the first amount of material can be less than 50 percent of the total amount of lens material.

The first amount of uncured lens material can be partially cured, for example, until the first amount of lens material can support the mask. Curing of the lens material can be done, for example, by applying heat or electromagnetic radiation to the lens material. The specific curing process or mechanism may be dependent upon the lens material being used. For example, in the case of acrylic lens materials, the curing process may involve the conversion of monomers into polymers, and a full cure may represent substantially full monomer conversion. As discussed herein, however, many different types of lens materials can be used. The lens material can be cured less than a full cure, e.g., at least about 20 percent and/or less than or equal to about 40 percent of a full cure. In some embodiments, partially curing the first amount of uncured lens material can include curing the material at least about 25 percent and/or less than or equal to about 35 percent of a full cure. In some embodiments, partially curing the first amount of uncured lens material can include curing the material at least about 25 percent and/or less than or equal to about 30 percent of a full cure. In some embodiments, partially curing the first amount of uncured lens material can include curing the material about 30 percent of a full cure. Other degrees of partial curing outside of these ranges may also be used in some embodiments. Partial curing allows the partially cured material to later inter-crosslink with the second amount of uncured lens material to create a homogeneous optical material.

A centration tool can be used to laterally center the mask along an optical axis of the intraocular lens. Alternatively, the tool can also be used to align the mask at any other desired lateral position even if the desired position does not correspond to the optical axis of the lens. The centration tool can also be used to longitudinally center the mask at the centroid of the lens body. Positioning the mask at the centroid of the intraocular lens may be desirable in some embodiments to provide symmetry. In addition, if the mask is not positioned at the centroid, thermal expansion can adversely affect the optical performance of the lens, for example, by disparately affecting the optical surfaces.

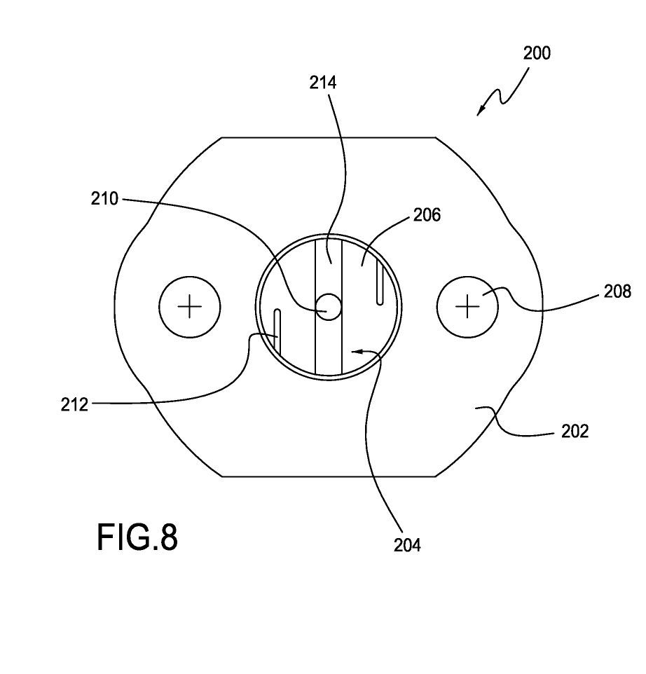

As shown in FIG. 8, the centration tool 200 can include a first section 202 and a second section 204. The first section 202 and the second section 204 can be integrally formed, or the second section can be over molded onto the first section. Alternatively, the second section 204 can be separably coupled with the first section 202. For example, the first section 202 can include depressions for engaging the second section 204.

The first section 202 can include an opening 206 that can center around a mold opening and correspond to the diameter of the lens. The first section 202 can also include additional openings 208 that can receive mold pins. Mold pins are commonly used to join the first mold section and the second mold section.

In some embodiments, the first section 202 can be a tine plate. The tine plate can include fibers 212 or other structures for creating openings in the lens body. These openings can later be used to attach haptics to the molded lens body.

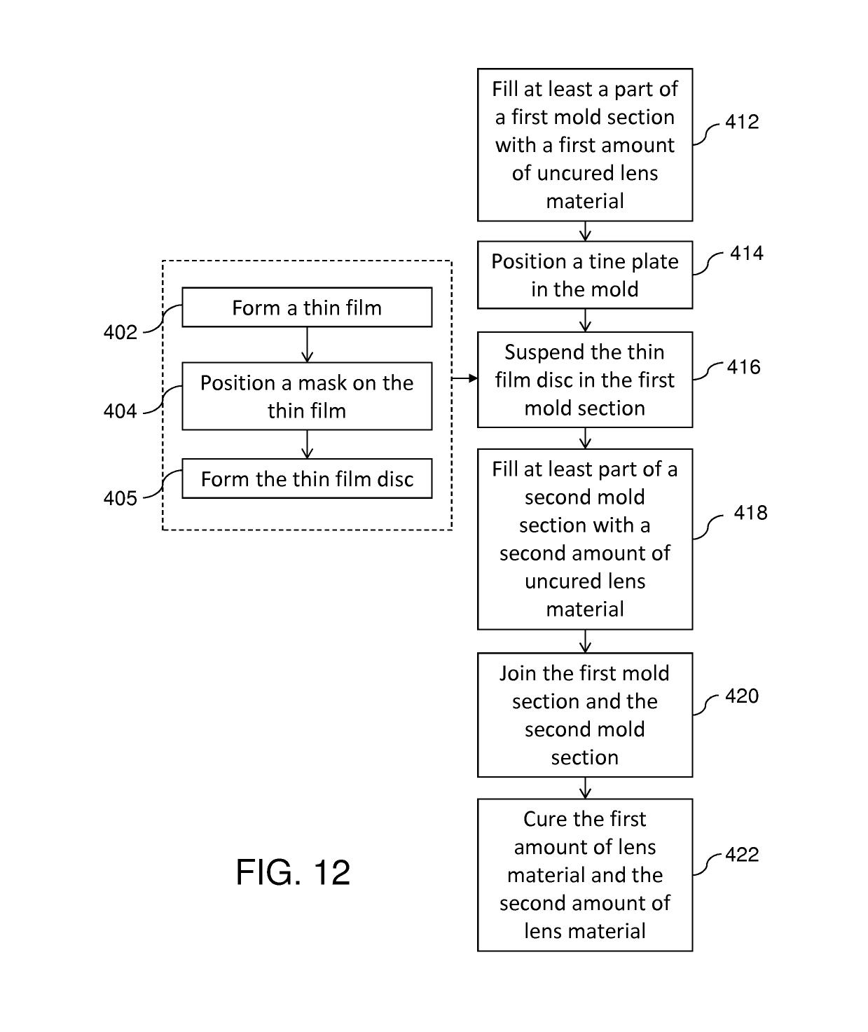

As shown in FIGS. 12A-12B, the second section 204 can include an elongated structure 214 extending across the opening 206 of the first section. This elongated structure 214 can be used to support the second section 204 of the centration tool with respect to the first section 202. The second section 204 can also include a raised element 210. The raised element 210 can be shaped and sized to be inserted within the central aperture of the mask such that the raised element can fixedly support the mask.

In some embodiments, the width of the elongated structure is less than or equal to about 1 mm. In some embodiments, the width of the elongated structure is at least about 1 mm and/or less than or equal to about 2 mm. In some embodiments, the width of the elongated structure can be about 1.4 mm.

In some embodiments, the diameter of the raised element can be at least about 1.0 mm and/or less than or equal to about 1.6 mm (e.g., corresponding with the size of the central aperture of the mask). In some embodiments, the diameter of the raised element can be about 1.3 mm.

In some embodiments, the thickness of the raised element can be at least about 0.03 mm and/or less than or equal to about 0.13 mm. In some embodiments, the thickness of the raised element can be about 0.08 mm. The thickness of the elongated structure can be about 0.250 mm.

In some embodiments, the length of the elongated structure can be at least about 10 mm and/or less than or equal to about 17 mm (e.g., generally corresponding with the diameter of the lens body). In some embodiments, the length of the elongated structure can be about 13.3 mm.

In some embodiments, the second section 204 can be formed of the same material as the lens material. This may be advantageous in embodiments where the second section 204 is left in place during the manufacturing process such that the second section 204 becomes a permanent part of the lens. For example, the structure of the second section 204 can be a web of lens material. The web can include a plurality of openings to allow the second amount of lens material to flow through the web and inter-crosslink with the first amount of lens material. As already discussed, the first and second sections can be separable. Thus, the first section 202 of the centration tool 200 can be removed, during or after formation of the lens, leaving the second section 204 and mask suspended and centered along an optical axis of the lens body.

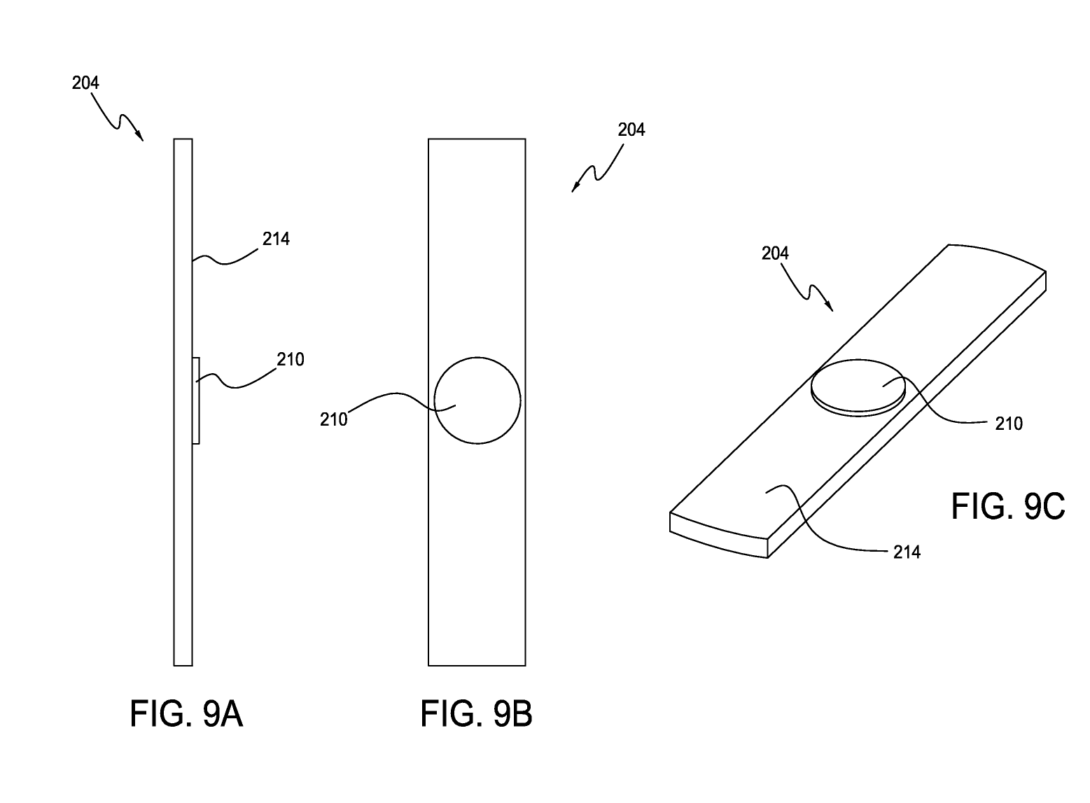

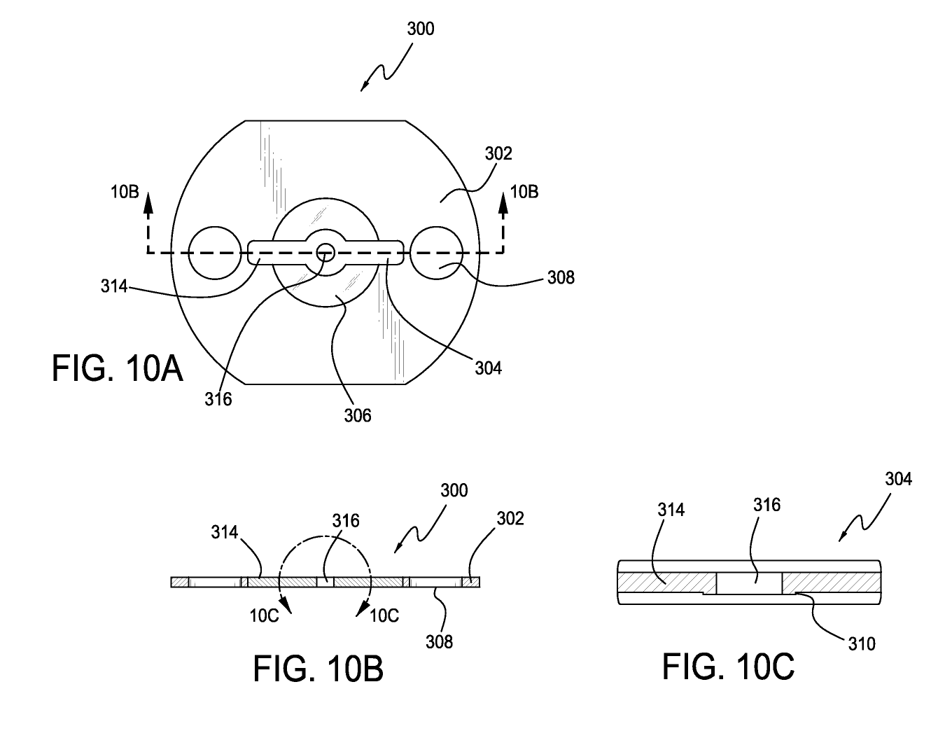

FIGS. 10A-10C illustrate another centration tool 300. The centration tool 300 can include any of the features of the centration tool 200. For example, the centration tool 300 can include a first section 302 and a second section 304, which can have similar features and functions as those discussed with respect to the centration tool 200 in FIGS. 9A-9C. For example, the second section 304 can include an elongated structure 314 extending across the opening 306 of the first section and an aperture 316. The aperture 316 can center along an optical axis of the lens body when the second section 304 is in the mold. The aperture 316 can be surrounded by a raised lip 310 that mates with the central aperture of the mask to hold it in place with respect to the centration tool 300. The second section aperture 316 facilitates the removal of any debris that may come to be located in the optical zone of the mask aperture when the mask is positioned on the centration tool in order to help prevent the formation of inclusions or other optical imperfections. The second section aperture 316 also permits the mask aperture to be filled with uncured lens material to ensure a homogenous optical material in the optical zone of the mask aperture.

In some embodiments, both the first section 302 and the second section 304 can be removed after centration is complete, leaving only the mask suspended and centered on the partially formed and partially cured lens body. After the centration tool 300 is removed, a separate tine plate can be inserted to form haptic openings in the lens body. Alternatively, tines can be incorporated with the first section 302 of the centration tool 302 (e.g., as shown in the first section 202 of the centration tool 200 in FIGS. 9A-9C), and only the second section 304 can be removed after the centration process is complete.

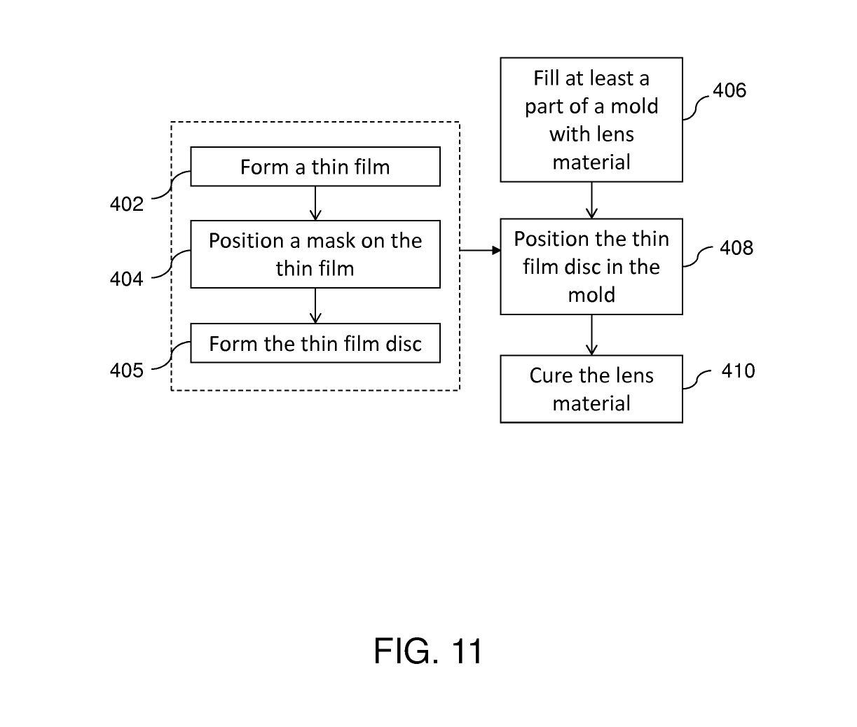

FIG. 11 illustrates another method of making the intraocular lens using a thin film disc as a centration tool. The method can include forming a thin film from a thin film material (block 402), positioning a mask on the thin film (block 404), and forming a thin film disc (block 405). At least a part of a mold can be filled with a lens material (block 406). The thin film disc can be positioned in the mold (block 408). The lens material can be cured to form the lens body (block 410).

FIG. 12 expands upon the method illustrated in FIG. 11. The method can include forming a thin film (block 402), positioning a mask on the thin film (block 404), and forming a thin film disc (block 405). As discussed herein, the thin film can be partially cured so as to support the mask. At least part of a first mold section can be filled with a first amount of uncured lens material (block 412). In some embodiments, the first amount of lens material can then be partially cured. A tine plate can be positioned in the mold. The thin film disc can be suspended in the first mold section (block 416). At least a part of a second mold section can be filled with a second amount of uncured lens material (block 418). The first mold section and the second mold section can be joined together (block 410). The first amount of uncured lens material and the second amount of uncured lens material can then be cured to form the lens body (block 422).

In some embodiments, the thin film material can include a lens material such as, for example, silicone or acrylic. In certain embodiments, the thin film material can include a mask material such as, a highly fluorinated polymer. In other embodiments, the thin film material can include polymers (e.g. PMMA, PVDF, polypropylene, polycarbonate, PEEK, polyethylene, acrylic copolymers (e.g., hydrophobic or hydrophilic), polystyrene, PVC, polysulfone), hydrogels, silicone, metals, metal alloys, carbon (e.g., graphene, pure carbon), or Dacron mesh.

A thin film of a desired thickness of uncured thin film material can be formed by, for example, spinning or spreading under the force of gravity. In some embodiments, the thickness of the thin film can be at least about 50 μm and/or less than or equal to about 400 μm. In some embodiments, the thickness of the thin film can be at least about 50 μm and/or less than or equal to about 150 μm. In some embodiments, the thickness of the film can be about 100 μm. The uncured thin film can be partially cured until the thin film can support a mask and still be easily manipulated. The mask can be positioned on the partially cured thin film and a thin film disc can be formed using a stamp, laser cutter, or other machine. The diameter of the thin film disc may correspond, for example, relatively precisely to the diameter of the lens such that suspending the thin film disc in the mold self-centers the aperture along an optical axis of the lens body. For example, the diameter of the thin film disc can be substantially the same as the diameter of the lens body. In some embodiments, the diameter of the thin film disc may also be greater than the diameter of the lens body, as discussed herein.

Depending on the thin film material, the amount of partial curing can vary. In some embodiments, the amount of partial curing allows for inter-crosslinking between the first amount of lens material, the thin film disc, and the second amount of lens material when the second amount of lens material is added to the mold. If the thin film material is the same as the lens material, then the lens material can inter-crosslink with the partially cured thin film material to form a homogenous lens body. If the thin film material is not the same as the lens material (e.g., an acrylic thin film disc and a silicone lens), then the thin film can be partially cured to permit the thin film to break during the lens body molding process such that the first amount of lens material can intercross link with the second amount of lens material to create a homogenous optical material. At the same time, the partially cured thin film material may still have integrity to support the mask and position the mask in the mold. For example, a partially cured acrylic thin film disc may have a thin layer of material over an uncured liquid inner portion. The thin layer of material may support the mask and will crosslink during the molding process after additional lens material is added to the mold.

If the thin film material is the same as the lens material, the partial curing can include curing the material at least about 20 percent and/or less than or equal to about 40 percent of a full cure. In some embodiments, the partial curing can include curing the material at least 25 percent and/or less than or equal to about 35 percent of a full cure. In some embodiments, the partial curing can include curing the material at least 25 percent and/or less than or equal to about 30 percent of a full cure. In some embodiments, the partial curing can include curing the material about 30 percent of a full cure.

Any of the masks disclosed herein can be positioned on the thin film (block 404). In some embodiments, however, the mask material can be formed, for example, by combining an uncured IOL material and an opacification agent. In some embodiments, the mask material can include any mask material described herein, such as a highly fluorinated polymer, other polymers (e.g. PMMA, PVDF, polypropylene, polycarbonate, PEEK, polyethylene, acrylic copolymers (e.g., hydrophobic or hydrophilic), polystyrene, PVC, polysulfone), hydrogels, silicone, metals, metal alloys, carbon (e.g., graphene, pure carbon), or Dacron mesh. The opacification agent can include a dye or carbon black.

In some embodiments, the mask material can be formed by combining uncured silicone and carbon black. The resulting mixture can be used to form a mask film having a thickness equal to the desired mask thickness. Techniques for forming the mask film can include allowing a drop of uncured lens material to spread to a desired thickness by gravity or by spinning. Each mask can then be formed from the mask film using a stamp, die, laser, or other machine. If an IOL includes a mask made from the same material as the IOL and the thin film, the material can advantageously be homogeneous throughout the IOL, as discussed herein. A silicone-based mask may also be desirable to prevent delamination of the mask. Further mask materials and methods of making a mask are disclosed in U.S. Pat. No. 7,976,577, filed Apr. 14, 2005, and U.S. Pub. No. 2011/0040376, filed Aug. 13, 2010, which are both hereby incorporated by reference in their entirety. Once the mask is formed, it can be positioned on the thin film, as discussed herein.

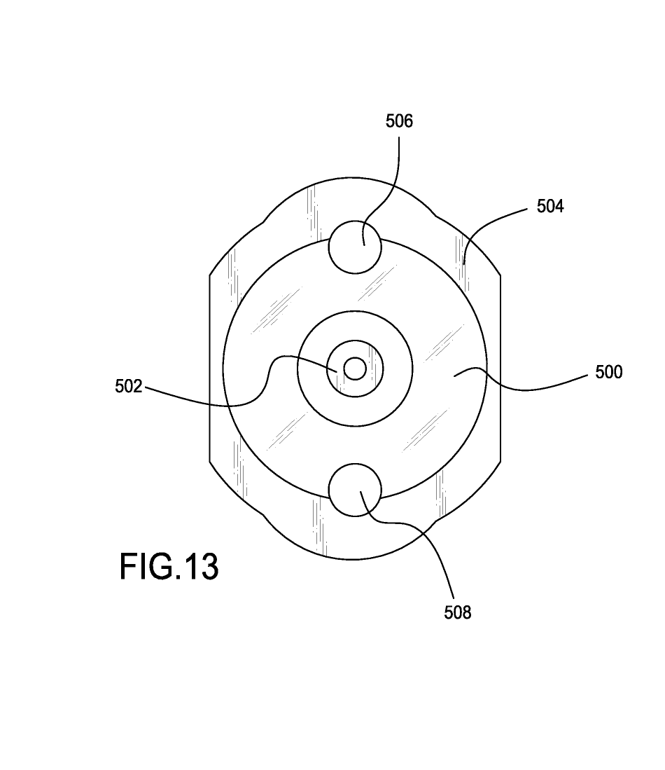

FIG. 13 illustrates a thin film disc 500 carrying a mask 502. The diameter of the disc 500 can be greater than a diameter of the lens body. Nevertheless, the thin film disc 500 can still be used to center the mask by being shaped with features to receive mold pins. For example, the disc 500 can include recesses 508 to receive the mold pins and to center the disc 500 in the mold. The recesses 508 can align the thin film disc 500 with the mold pins and, consequently, with the lens mold.

The thin film disc 500 can be positioned in the mold using an insert 504. The insert 504 can include one or more openings 506 to receive mold pins and center the insert 504 in the mold. As shown in FIG. 13, the thin film disc 500 can adhere to the insert 504. The recesses 508 of the thin film disc 500 can align with the openings 506 of the insert 504. After the insert 504 positions the thin film disc 500 in the mold, the insert 504 can be removed leaving the thin film disc 500 centered in the mold and the mask aligned with the optical axis of the lens body. If the thin film disc 500 has a diameter greater than the diameter of the lens body, the excess diameter of the disc 500 can be removed when the first mold section is joined to the second mold section. In some embodiments, the insert 504 can be a tine plate. As already discussed, the tine plate can include fibers or other structures to create openings in the lens body, which can be used to attach haptics to the lens body.

Various embodiments have been described above. Although the invention has been described with reference to these specific embodiments, the descriptions are intended to be illustrative and are not intended to be limiting. Various modifications and applications may occur to those skilled in the art without departing from the true spirit and scope of the invention as defined in the appended claims.

What is claimed is:

1. A method of manufacturing an intraocular lens comprising:
partially curing a first amount of uncured lens material to form at least part of a lens body;
suspending a mask on the partially cured lens material;
adding a second amount of uncured lens material to the partially cured lens material; and
curing the second amount of uncured lens material and the partially cured lens material to form the lens body, the lens body comprising the mask therein.

2. The method of claim 1, wherein partially curing the first amount of uncured lens material comprises curing the first amount of uncured lens material between about 20 percent and about 40 percent of a full cure.

3. The method of claim 2, wherein partially curing the first amount of uncured lens material comprises curing the first amount of uncured lens material to about 30 percent of a full cure.

4. The method of claim 1, wherein the first amount of uncured lens material comprises about 50 percent of a total amount of uncured lens material used to form the lens body.

5. The method of claim 1, wherein suspending the mask comprises centering the mask along an optical axis of the intraocular lens.

6. The method of claim 5, wherein centering the mask comprises using a centration tool.

7. The method of claim 6, further comprising, before curing the uncured lens material and the partially cured lens material, removing the centration tool.

8. The method of claim 6, wherein the centration tool comprises a tine plate.

9. The method of claim 1, wherein the mask comprises a plurality of holes characterized in that at least one of a hole size, shape, orientation, and spacing of the plurality of holes is varied to reduce the tendency of the holes to produce visible diffraction patterns.

10. The method of claim 9, wherein the plurality of holes are positioned at irregular locations.

11. The method of claim 9, wherein the lens body extends at least partially through the plurality of holes of the mask.

12. The method of claim 9, further comprising flowing the uncured lens material through the plurality of holes.

13. A method of manufacturing an intraocular lens comprising:
forming a thin film from a thin film material;
positioning a mask on the thin film;
filling at least a part of a mold with a lens material;
suspending the thin film in the mold; and
curing the lens material.

14. The method of claim 13, wherein suspending the thin film in the mold comprises centering the mask along an optical axis of the intraocular lens.

15. The method of claim 14, wherein centering the mask comprises using one or more pins of the mold to center the mask.

16. The method of claim 13, wherein suspending the thin film in the mold comprises centering an insert along an optical axis of the intraocular lens.

17. The method of claim 13, wherein forming a thin film comprises partially curing the thin film material.

18. The method of claim 17, wherein partially curing the thin film material comprises curing the thin film material between about 20 percent and 40 percent of a full cure.

19. The method of claim 13, wherein the thin film material comprises silicone.

20. The method of claim 13, wherein the thin film material comprises acrylic.

21. The method of claim 13, wherein the thin film material is the same as the lens material.

22. The method of claim 13, wherein the mask comprises a mask material, the mask material being the same as the lens material.

23. The method of claim 13, wherein the mask comprises a mask material, the mask material being the same as the thin film material.

24. The method of claim 13, wherein a diameter of the thin film is greater than a diameter of the intraocular lens.

25. The method of claim 24, further comprising removing an excess diameter of the thin film by joining a first mold section and a second mold section.

26. The method of claim 13, further comprising filling the remainder of the mold with the lens material after suspending the thin film in the mold.

27. A centration tool for suspending a mask in an intraocular lens, the centration tool comprising:
a first section having a diameter at least as large as a diameter of the intraocular lens; and
a second section having a raised element centered along an optical axis of the intraocular lens, the raised element configured to support and position the mask such that it can be formed in the intraocular lens.

28. The centration tool of claim 27, wherein the first section and the second section are separable.

29. The centration tool of claim 27, wherein the first section comprises a tine plate.

30. The centration tool of claim 27, wherein the first section comprises at least one aperture through which a corresponding pin of a mold extends when the intraocular lens is being formed.

31. The centration tool of claim 27, wherein the second section comprises an aperture.

32. The centration tool of claim 27, wherein the second section includes at least one elongated member to support the second section with respect to the first section.
